(19) United States
(12) Patent Application Publication
(10) Pub. No.: US 2023/0052550 A1
(43) Pub. Date: Feb. 16, 2023

(54) DEVICE FOR RECOVERING AND REGULATING THERMAL ENERGY OF AN ELECTRIC VEHICLE WITH ELECTROCHEMICAL GENERATOR WITH AN HVAC SYSTEM

(71) Applicant: Belenos Clean Power Holding AG, Biel/Bienne (CH)

(72) Inventor: Rexhep GASHI, Givisiez (CH)

(73) Assignee: Belenos Clean Power Holding AG, Biel/Bienne (CH)

(21) Appl. No.: 17/760,177

(22) PCT Filed: Jan. 14, 2021
(86) PCT No.: PCT/EP2021/050703

§ 371 Date: Aug. 4, 2022

(30) Foreign Application Priority Data
Feb. 6, 2020 (EP) 20155848.3

(51) Int. Cl. B60H 1/14; B60H 1/00; B60H 1/32

(52) U.S. Cl. CPC B60H 1/143; B60H 1/00385; B60H 1/323; B60H 1/00878; B60H 2001/00949; B60H 2001/00928

(57) ABSTRACT

A device for recovering and regulating thermal energy of an electric vehicle with an electrochemical generator wherein a fluid circulates, includes an air-conditioning circuit, a first heating or thermal energy recovery circuit for heating and a second cooling or thermal energy recovery circuit for cooling the electrochemical generator, an electric motor, an electronic circuit, and a braking circuit. A plurality of valves are arranged to put the air- conditioning circuit in communication with the first heating circuit or second cooling circuit, and means for controlling said valves arranged to allow, according to a temperature of the electrochemical generator, of the electric motor, of the electronic circuit and of the braking circuit, the circulation of the fluid from the air-conditioning circuit in the first heating circuit for a heating operation as well as the circulation of the fluid from the air-conditioning circuit in the second cooling circuit for a cooling operation.

### Field of the invention

The invention relates to a device for recovering and regulating thermal energy of an electric vehicle with an electrochemical generator, such as a battery, fuel cell or hybrid, with an HVAC system. The device for recovering and regulating thermal energy comprises an air-conditioning circuit of an HVAC (heating-ventilation-air conditioning-cooling) system for the cabin of the vehicle, wherein a fluid circulates, said air conditioning circuit comprising at least one external condenser-evaporator, a compressor, an internal condenser intended to heat the cabin, a first expansion orifice provided downstream of the internal condenser, between the internal condenser and the external condenser/evaporator, an internal evaporator intended to cool the cabin, and a second expansion orifice provided upstream of the internal evaporator, between the external condenser/evaporator and the internal evaporator.

### Background of the Invention

Such devices are known to a person skilled in the art, and are in particular used in electrical or hybrid vehicles for replacing the electric heating systems with heating elements that consume a great deal of electricity. HVAC systems also have the advantage of transforming themselves into air conditioning in the summer. HVAC systems are the most effective for regulating the temperature of the vehicle cabin while optimizing the electrical energy consumption of the vehicle. They thus make it possible to increase the range thereof.

Still for the purpose of increasing the range of an electric or hybrid vehicle, it is also sought to optimize the energy efficiency of the electrochemical generator by regulating the temperature thereof. This is because the temperature has a great influence on the functioning of the electrochemical generator: the electrochemical generator must be cooled when the temperature thereof is too high, or heated when the temperature thereof is too low. In particular, in winter, an excessively low temperature of the electrochemical generator causes a very great drop in efficiency so that the range of the vehicle may be reduced by half. In addition, when the electrochemical generator is a battery, the curves of the state of charge as a function of charging time of the battery indicate that the charging time increases with temperature. Furthermore, because of the rise in temperature during charging, the charging time is relatively quick for reaching 80% of the charge but is then very long for reaching 100% of the charge.

In this regard, the patent CH 711 726 B1 describes a device for regulating the temperature of an electrochemical generator, such as a battery or fuel cell or hybrid, of an electric vehicle as shown in FIGS. 1 to 5, as explained in detail below as prior art.

With reference for example to FIG. 1, the device for regulating the temperature of an electrochemical generator of an electric or hybrid vehicle comprises an air-conditioning circuit of an HVAC system for the cabin of the vehicle. This FIG. 1 shows a method for heating for example the battery under charge with the vehicle stopped.

More particularly, the air-conditioning circuit comprises, in a first loop, in the direction of circulation of a fluid, an external condenser/evaporator 2, generally situated at the front of the vehicle, an accumulator 3, a compressor 4, preferably high speed, an internal condenser 6 intended to heat the cabin, and a first expansion orifice 8 provided downstream of the internal condenser, between the internal condenser 6 and the external condenser/evaporator 2. A bypass 10 is provided between the internal condenser 6 and the external condenser/evaporator 2, at the first expansion orifice 8. A second loop comprises a second expansion orifice 12 provided upstream of the internal evaporator 14, between the external condenser/evaporator 2 and the internal evaporator 14, and which is intended to cool the cabin. A fan 16 of the air-conditioning unit is provided at the internal evaporator 14. The various elements are connected together by conduits in which a refrigerating fluid circulates, such as a refrigerant gas. The circulation in the first loop or in the second loop and the bypass is controlled by means of a set of valves, 18, 20, 21, 28, 32, 36, 38. The valves 18 and 20 are provided at the intersection of the first loop and of the second loop, and the valve 21 is provided at the intersection of the first loop and of the bypass 10, upstream of the first expansion orifice 8. These valves are for example solenoid valves with at least 3 ways except for example for the valve 20 with at least 4 ways.

It should be noted that the circulation of the gaseous fluid in the conduits in this embodiment is shown in FIG. 1 by darker lines for this method of heating the battery under charge with the vehicle stopped. The same applies with the following FIGS. 2 to 5.

The regulation device further comprises a first circuit for heating the electrochemical generator 1 wherein the same fluid as in the air- conditioning circuit is able to circulate. The first circuit for heating the electrochemical generator comprises, in the direction of circulation of the fluid, a first conduit for supplying fluid 22 to a heat-transfer element associated with the electrochemical generator 1. The first supply conduit 22 is connected to a first outlet provided between the compressor 4 and the internal condenser 6 by means of a 3-way valve 24, and a first conduit for discharging fluid 26 from the heat-transfer element. The first discharge conduit 26 is connected to a first inlet provided between the internal condenser 6 and the first expansion orifice 8 by means of a 3-way valve 28.

The regulation device further comprises a second circuit for cooling the electrochemical generator 1 wherein the same fluid is able to circulate as in the air-conditioning circuit. The second circuit for cooling the electrochemical generator 1 comprises, in the direction of circulation of the fluid, a second conduit for supplying fluid 30 to a heat-transfer element associated with the electrochemical generator 1. The second supply conduit 30 is connected to a second outlet provided between the second expansion orifice 12 and the internal evaporator 14 by means of a 3-way valve 32, and a second conduit for discharging the fluid 34 from the heat- transfer element. The second discharge conduit 34 is connected to a second inlet provided downstream of the internal evaporator 14, between the internal evaporator 14 and the compressor 4, by means of the valve 20 that consists of a 4-way valve.

It should be noted that, for this description, it must be understood that the air-conditioning circuit comprises the first heating circuit and the second cooling circuit, even if generally, for air conditioning, this mainly concerns the passage of the gas through the second expansion orifice 12 (pressure reducer). The first heating circuit and the second cooling circuit are fitted one in the other and are dependent on the control of the various valves by the control means for fulfilling their function.

The first conduit 22 and the second conduit 30 supplying the fluid to the heat-transfer element of the electrochemical generator 1 are connected to said heat-transfer element solely by a 3-way valve 36. Likewise, the first conduit 26 and the second conduit 34 discharging the fluid from the heat- transfer element are connected to said heat-transfer element solely by a 3-way valve 38. It is also possible to provide separate and independent connections to the heat-transfer element. It is also possible to provide an exchanger between the valves 36, 38 and the electrochemical generator 1 in order to favor the heat exchanges.

The valves 24, 28, 32 and 20 constitute the valves arranged to be able to put the air-conditioning circuit in communication with one or other of the first heating circuit and the second cooling circuit of the electrochemical generator 1.

The regulation device comprises means for controlling the valves 24, 28, 32, 20, 36 and 38 arranged to allow, according to the temperature of the electrochemical generator 1, the circulation of the fluid of the air-conditioning circuit in the first heating circuit in order to heat the electrochemical generator 1 and/or the circulation of the fluid of the air-conditioning circuit in the second cooling circuit in order to cool the electrochemical generator 1, so as to regulate the temperature thereof.

Other means for controlling the valves of the air-conditioning circuit are provided for the functioning of said valves 18, 20 and 21 for regulating the temperature of the cabin, in addition to the regulation of the temperature of the electrochemical generator.

The control means are associated with temperature sensors of the electrochemical generator 1 in order to actuate the valves according to the effect sought depending on whether the vehicle is stopped or travelling, and according to the presence of a battery or of a fuel cell. According to FIGS. 1 to 5, the circulation of the gaseous fluid in the conduits in the embodiments is shown by darker lines. FIG. 1 shows the heating mode for the battery 1 under charge with the vehicle stopped. FIG. 2 shows a cooling mode for the battery 1 under charge with the vehicle stopped. FIG. 3 shows a heating mode of the cabin and heating of the battery 1 with the vehicle traveling. FIG. 4 shows a mode for air conditioning the cabin and cooling the battery 1, the vehicle being traveling. Finally, FIG. 5 shows a mode for heating the cabin and cooling the battery 1, the vehicle being traveling.

More particularly, when the vehicle is stopped, the means for controlling the valves, the compressor 4 and all the electronic components are arranged so as to function on the mains, the vehicle being connected to the mains, or not.

The means for controlling the valves may be arranged to make the internal condenser 6 and the internal evaporator 14 inoperative vis-a-vis the regulation of the temperature of the cabin, when the vehicle is stopped, so that only the battery heating or cooling modes are operational.

When the outside temperature is cold, it is necessary to heat the battery or the fuel cell in order to facilitate starting of the vehicle, as well as to heat the battery in order to improve the efficacy of the charging thereof. In the case of the heating mode for the electrochemical generator 1, the vehicle being stopped, and in the case of the battery, said battery being able to be under charge, according to FIG. 1, the means for controlling the valves are arranged so that the fluid that passes through the external condenser/evaporator 2, in contact with the cold air A, flows towards the accumulator 3 via the valves 18 and 20, and then in the compressor 4, where it is compressed, and therefore heated, and then sent, via the valve 24, into the first conduit 22 supplying the heating circuit of the electrochemical generator as far as the heat-transfer element of the electrochemical generator 1 via the valve 36. During its passage, the fluid reheats the heat-transfer element, which heats the electrochemical generator 1. Then the fluid circulates in the first discharge conduit 26 of the heating circuit of the electrochemical generator 1 via the valve 38, joins the air-conditioning circuit via the valves 28, 21 and regains the external condenser/evaporator 2 by passing through the first expansion orifice 8. In this mode, the internal condenser 6 and the evaporator 14 are not active.

If, at the time of starting, the electrochemical generator is too hot, or if, at the time of charging, the battery is too hot, because of excessively hot outside air so that the electrochemical generator must be cooled, then the means controlling the valves are arranged to go into the electrochemical-generator cooling mode, the vehicle being stopped. In the case of the battery, said battery may be on charge, in accordance with FIG. 2. The means controlling the valves are then arranged so that the fluid that is passing through the external condenser/evaporator 2, in contact with the hot air B, circulates towards the second conduit 30 supplying the cooling circuit of the electrochemical generator via the valve 18, the second expansion orifice 12 where it is cooled, and the valve 32, as far as the heat-transfer element of the battery 1 via the valve 36. As it passes, the fluid cools the heat-transfer element, which cools the electrochemical generator 1. Then the fluid flows in the second discharge conduit 34 of the cooling circuit via the valve 38, and rejoins the air- conditioning circuit via the valve 20, in order to pass through the accumulator 3 and the compressor 4, where it is compressed, the internal condenser 6 via the valve 24, said internal condenser being made inoperative vis-a-vis the regulation of the cabin by means of an obturator 40. Then the fluid flows in the bypass 10 via the valves 21 and 28 and then regains the external condenser/evaporator 2, without passing through the first expansion orifice 8. In this mode, the internal condenser 6 and the evaporator 14 are not active vis-a-vis the regulation of the temperature of the cabin.

When the electrochemical generator is a battery, the means controlling the valves are arranged so as to allow the circulation of the fluid in the first heating circuit in order to heat the battery until it reaches an optimum charging temperature and to allow circulation of the fluid of the air-conditioning circuit in the second cooling circuit in order to cool the battery so as to regain the optimum charging temperature, in order to charge the battery in as short a time as possible. In this case, the means controlling the valves are arranged to go from the battery-heating mode, the vehicle being stopped and the battery under charge, in accordance with FIG. 1, to the battery cooling mode, the vehicle being stopped and the battery under charge, in accordance with FIG. 2, and vice versa, automatically, according to the optimum temperature of the battery to be maintained in order to charge the battery in as short a time as possible. The optimum charging temperature for the battery may be between 5 and 25° C.

In the various cases described above, the means controlling the valves are managed automatically, without any human action. This is used in particular for maintaining the temperature of the battery at an ideal charging temperature.

When the vehicle is stopped, it is possible to use the thermal energy supplied by the electrochemical generator 1 in order to regulate the temperature of the cabin. It is thus possible to program the battery charging time in order to heat it sufficiently and to profit from the heat given off by the battery during charging thereof in order to heat the cabin or to cool it sufficiently and to profit from the cold given off by the battery during charging thereof in order to cool the cabin. In this case, the means controlling the valves are arranged to allow the functioning of the internal condenser 6 and of the internal evaporator 14 when the vehicle is stopped and to regulate the temperature of the cabin in addition to the temperature of the electrochemical generator 1. Thus the temperature of the cabin is comfortable when the user sits in the vehicle in order to start it.

When the vehicle is traveling, the means controlling the valves and the compressor 4 are arranged so as to function on the electrochemical generator.

According to another variant, the means controlling the valves are arranged to allow the functioning of the internal condenser 6 and of the internal evaporator 14 when the vehicle is traveling and to regulate the temperature of the cabin in addition to the temperature of the electrochemical generator.

More specifically, when the outside temperature is cold, the means controlling the valves are arranged to change the HVAC system to cabin- heating mode and to allow the circulation of the fluid of the air-conditioning circuit in the first heating circuit of the electrochemical generator in order to heat the cabin and the electrochemical generator when the vehicle is traveling, as shown by FIG. 3. In this case of the mode for heating the cabin and the electrochemical generator, the means controlling the valves are arranged so that the fluid, which is passing through the condenser/evaporator 2, in contact with the cold air A, flows towards the accumulator 3 via the valves 18 and 20, and then in the compressor 4, where it is compressed, and therefore heated, and then sent, via the valve 24, firstly into the first conduit 22 supplying the heating circuit of the electrochemical generator as far as the heat-transfer element of the electrochemical generator 1 via the valve 36, and secondly into the internal condenser 6. The fan of the air-conditioning unit 16 is arranged so as to be open so that the cold air entering at C is heated by passing through the internal condenser 6 before being sent into the cabin in order to heat it. Then the fluid leaves again in the direction of the external condenser/evaporator 2, passing through the first expansion orifice 8. At the heating circuit of the electrochemical generator, the fluid reheats the heat-transfer element, which heats the electrochemical generator 1. Then the fluid flows in the first discharge conduit 26 of the heating circuit of the electrochemical generator via the valve 38, rejoins the air-conditioning circuit via the valves 28 and 21 and regains the external condenser/evaporator 2 by passing through the first expansion orifice 8. In this mode, the internal condenser 6 is active vis-a-vis the regulation of the temperature of the cabin. In this mode, the regulation device makes it possible to produce heat in order to heat the cabin on the one hand and to heat the electrochemical generator on the other hand in order to maintain it at an optimum temperature so as to ensure better efficacy.

If the electrochemical generator becomes too hot, when the vehicle is traveling, because for example of a very high traction power load, or the outside air is too hot, so that the electrochemical generator must be cooled, then the means controlling the valves are arranged to move the HVAC system into cabin air-conditioning mode. In addition, this makes it possible to enable the circulation of the fluid of the air-conditioning circuit in the second cooling circuit of the electrochemical generator in order to cool the cabin and the electrochemical generator, in accordance with FIG. 4. The means controlling the valves are then arranged so that the fluid that passes through the external condenser/evaporator 2, in contact with the hot air B, is oriented, via the valve 18, to the second expansion orifice 12, where it is cooled, and then to the valve 32 where the fluid is divided firstly towards the second conduit 30 supplying the cooling circuit of the electrochemical generator as far as the heat-transfer element of the electrochemical generator 1 via the valve 36, and secondly towards the internal evaporator 14. The fan of the air-conditioning unit 16 is arranged so as to be open so that the hot air entering at D is cooled by passing through the internal evaporator 14 before being sent into the cabin in order to cool it. Then the fluid moves again into the air-conditioning circuit via the valve 20. Alongside the cooling circuit of the electrochemical generator 1, the fluid, after having cooled the electrochemical generator 1, flows in the second discharge conduit 34 of the cooling circuit via the valve 38, rejoins the air-conditioning circuit via the valve 20, in order, with the fluid coming from the internal evaporator 14, to pass through the accumulator 3, the compressor 4, where it is compressed, and the internal condenser 6 via the valve 24, said internal condenser being made inoperative vis-a-vis the regulation of the cabin by means of the obturator 40. Then the fluid flows in the bypass 10 via the valves 21 and 28 and then regains the external condenser/evaporator 2, without passing through the first expansion orifice 8. In this mode, the regulation device makes it possible to produce cold in order to cool the cabin on the one hand and to cool the electrochemical generator on the other hand in order to maintain it at an optimum temperature for ensuring better efficacy.

If the electrochemical generator becomes too hot when the vehicle is traveling, because for example of intensive functioning, so that the electrochemical generator must be cooled but the outside air is cold and the cabin must be heated, then the means controlling the valves are arranged to move the HVAC system into cabin heating mode and to allow the circulation of the fluid of the air-conditioning circuit in the second cooling circuit of the electrochemical generator in order to heat the cabin and to cool the electrochemical generator, in accordance with FIG. 5. The means controlling the valves are then arranged so that the fluid that is passing through the condenser/evaporator 2, in contact with the cold air A, is oriented via the valve 18, firstly directly to the valve 20 and secondly to the second expansion orifice 12, where it is cooled, and then, via the valve 32, in the second conduit 30 supplying the cooling circuit of the electrochemical generator as far as the heat-transfer element of the electrochemical generator 1 via the valve 36. The fluid, after having cooled the electrochemical generator 1, flows in the second discharge conduit 34 of the cooling circuit via the valve 38, and rejoins the air-conditioning circuit via the valve 20 in order, with the fluid coming directly from the valve 18, to pass through the accumulator 3, the compressor 4, where it is compressed, and the internal condenser 6 via the valve 24. The fan of the air-conditioning unit 16 is arranged to be open so that the cold air entering at E is heated while passing through the internal condenser 6 before being sent into the cabin in order to heat it. Then the fluid passes through the first expansion orifice 8 via the valve 21 and regains the external condenser/evaporator 2. In this mode, the regulation device makes it possible to produce heat in order to heat the cabin on the one hand and to produce cold in order to cool the electrochemical generator on the other hand so as to maintain it at an optimum temperature for ensuring a best efficacy, the heat produced by the electrochemical generator being used for heating the cabin.

In these three modes for regulating the temperature where the automobile is traveling, the means controlling the valves are managed semi-automatically, the user acting in order to move the HVAC system into heating mode or into cabin air-conditioning mode in order to regulate the temperature of the cabin, the temperature of the electrochemical generator being controlled automatically by means of the temperature sensors.

The patent U.S. Pat. No. 10,168,079 B2 describes a device with refrigeration cycles, in particular for the battery. However, provision is not made for recovering thermal energy from a vehicle element in order to heat or cool for example the battery or for the cabin of the vehicle. In addition, only a very approximate gas-air exchanger is used in the air-conditioning circuit, without the possibility of regulating the temperature of the battery precisely.

### Summary of the Invention

The objective of the invention is in particular to overcome the various drawbacks of the electrochemical generators equipping the known electric or hybrid vehicles and to make provision for connecting, in the heating circuit or the cooling circuit, also at least one electric motor of the vehicle and at least one electronic control circuit and an electrochemical generator for recovering and regulating the thermal energy in order to optimize the overall efficiency of such a vehicle and to transform the thermal losses into positive energy for regulating the temperature in the cabin.

More precisely, an objective of the invention is to provide a device for recovering and regulating thermal energy of an electric vehicle with an electrochemical generator, such as a battery or fuel cell or hybrid, with an HVAC system allowing in particular the recovery of the thermal energy for the electrochemical generator in order to optimize the energy efficiency thereof. Recovery of the heating or cooling thermal energy is also provided for at least the electric motor and at least the electronic control circuit in connection with the electrochemical generator, or even also with the braking energy, in order to increase the range of the vehicle.

Another objective of the invention, when the electrochemical generator is a battery, is to provide a device for recovering thermal energy when the battery is charged in order to optimize the charging time and to make it as short as possible.

For this purpose, the present invention relates to a device for recovering and regulating thermal energy of an electric vehicle with an electrochemical generator, which comprises the features of independent claim 1.

Particular embodiments of the thermal-energy recovery and regulation device are defined in the dependent claims 2 to 11.

Thus the thermal-energy recovery and regulation device of the invention makes it possible to optimize the energy efficiency of the electrochemical generator, and in connection with the electric traction motor and the electronic control circuit in order to increase the range of the vehicle. In addition, when the electrochemical generator is a battery, the thermal-energy recovery and regulation device of the invention makes it possible to optimize the battery charging time by making it as short as possible.

One advantage of the thermal-energy recovery and regulation device lies in the fact that the electronic control traction motor is connected to the heating circuit or to the cooling circuit with the battery, which makes it possible to avoid any loss of thermal energy and to guarantee that the vehicle has an increase in the range thereof before another charging of the battery.

### Summary description of the drawings

Other features and advantages of the invention will emerge more clearly from a reading of the following description of various embodiments of the invention, given by way of simple illustrative and non-limitative examples, and the accompanying figures, among which:

FIG. 1 shows a schematic view of a device for regulating the temperature of an electrochemical generator of an electric vehicle, the vehicle being at rest and the battery under charge, of the prior art,

FIG. 2 shows a schematic view of a device for regulating the temperature of an electrochemical generator of an electric vehicle, the vehicle being at rest and the battery under charge, of the prior art,

FIG. 3 shows a schematic view of a device for regulating the temperature of an electrochemical generator of an electric vehicle, the vehicle being traveling, of the prior art,

FIG. 4 shows a schematic view of a device for regulating the temperature of an electrochemical generator of an electric vehicle, the vehicle being traveling, of the prior art,

FIG. 5 shows a schematic view of a device for regulating the temperature of an electrochemical generator of an electric vehicle, the vehicle being traveling, of the prior art,

FIG. 6 shows a schematic view of a first embodiment of the device for recovering and regulating thermal energy of an electric vehicle with an electrochemical generator according to the invention,

FIG. 7 shows a schematic view of a second embodiment of the device for recovering and regulating thermal energy of an electric vehicle with an electrochemical generator according to the invention,

FIG. 8 shows a schematic view of a third embodiment of the device for recovering and regulating thermal energy of an electric vehicle with an electrochemical generator according to the invention, and

FIG. 9 shows an arrangement of the electric motor, of the electronics, of the electrochemical generator and of a braking circuit for the recovery of thermal energy of the braking circuit and the direct charging of the electrochemical generator by the motor according to the invention.

### DETAILED DESCRIPTION OF THE PREFERRED EMBODIMENTS

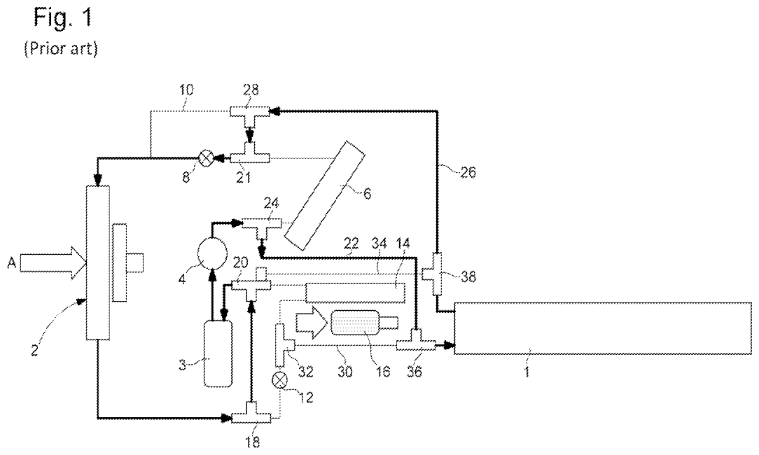

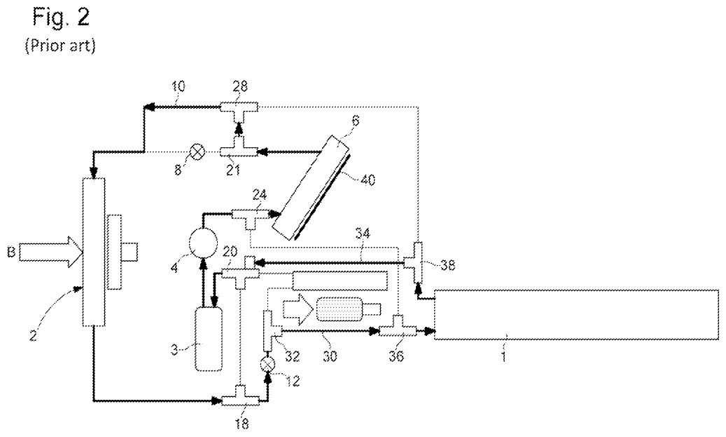

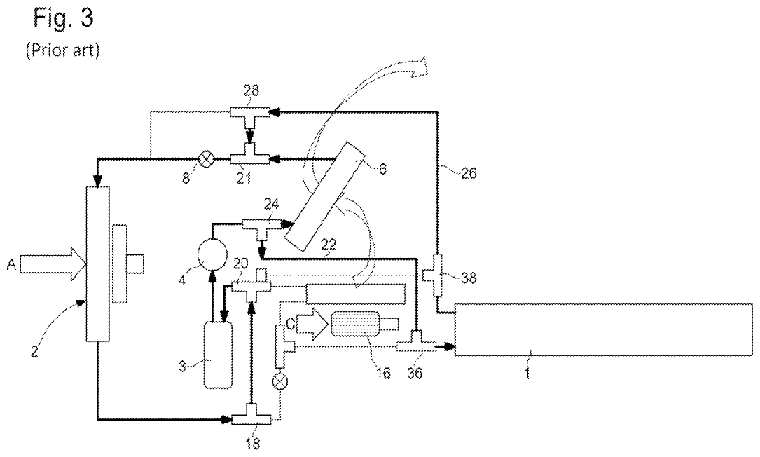

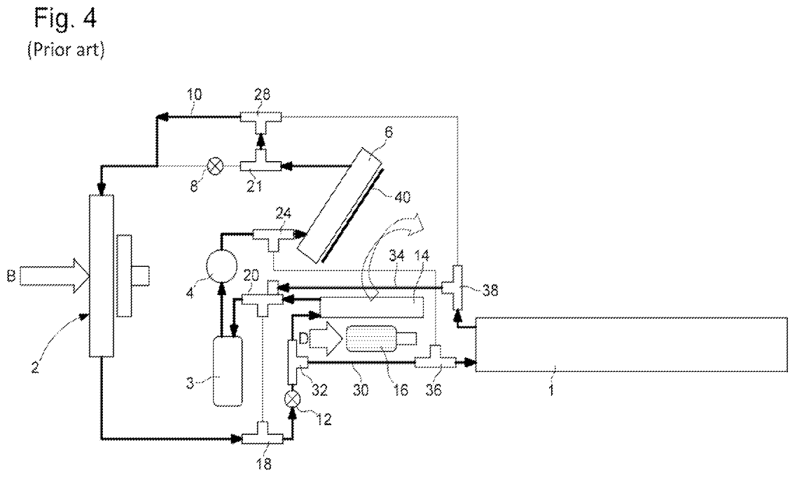

In the present description, the term electrochemical generator designates the batteries and the fuel cells used in electrical hybrid vehicles, indicated in the figures by the reference 1 indifferently for a battery or a fuel cell. In addition, a thermal energy recovery and regulation device is defined rather than a temperature regulation device for an electrochemical generator as described with reference to FIGS. 1 to 5 of the prior art.

The thermal energy recovery and regulation device of the vehicle with an electrochemical generator of the present invention comprises an air-conditioning circuit identical to what was described with reference to the preceding FIGS. 1 to 5 in the prior art. Because of this not all the components of said device and the various embodiments illustrated by the preceding FIGS. 1 to 5 will be repeated in their entirety. Everything that relates to the functioning of the various elements of the device with regard to the air-conditioning circuits is identical and will not be repeated. Only the novel components related to the heating circuit or to the cooling circuit of the device of the air-conditioning circuit will be described in detail and the ability thereof to recover the energy in order to supply it to another component of the device. The importance of this invention is to be able to use the heating or cooling thermal energy of certain components in operation and connected to the heating circuit or to the cooling circuit in order to heat or cool for example the cabin of the electric vehicle without any appreciable loss of thermal energy.

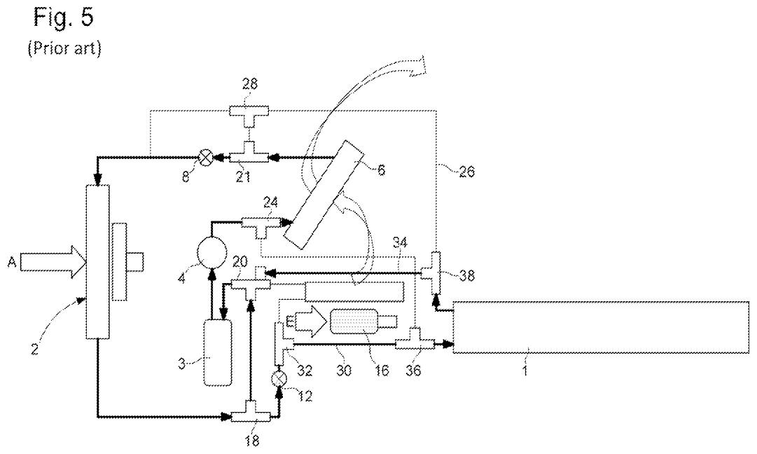

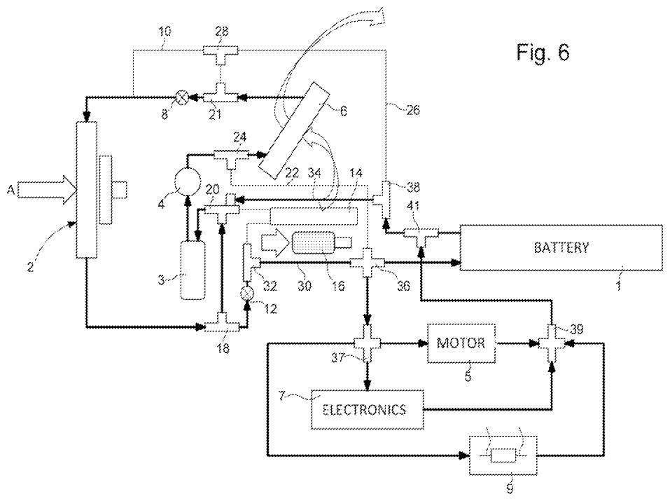

FIG. 6 shows a first embodiment of the novel thermal energy recovery and regulation device of the vehicle with electrochemical generator 1, which comprises an air-conditioning circuit of an HVAC system of the vehicle cabin. For example, according to this first embodiment seen in FIG. 6 and in principle equivalent to FIG. 5, a method for heating the cabin and cooling the electrochemical generator 1 is presented, with at least one electric motor 5 and at least one electronic circuit 7 or electronic equipment. However, all the components in FIG. 6 are described with the novel arrangement of at least the electric motor 5 and at least the electronic circuit 7 in conjunction with the electrochemical generator 1. The electric motor or motors 5 are for the traction of the vehicle, whereas the electronic circuit 7 can serve for controlling the electric motor or motors 5.

As described with reference to FIGS. 1 to 5, said air-conditioning circuit therefore comprises an air-conditioning circuit of an HVAC system of the cabin of the vehicle, wherein a fluid circulates. The fluid, for example refrigerant, such as a refrigerant gas, circulates in particular in various conduits. This air-conditioning circuit comprises at least one external condenser/evaporator 2, generally situated at the front of the vehicle, a compressor 4, preferably high speed, an internal condenser 6 for heating the cabin, a first expansion orifice 8 provided downstream of the internal condenser 6 between the internal condenser 6 and the external condenser/evaporator 2, an internal evaporator 14 for cooling the cabin, and a second expansion orifice 12 provided upstream of the internal evaporator 14, between the external condenser/evaporator 2 and the internal evaporator 14.

The thermal energy recovery and regulation device also comprises a first heating or thermal energy recovery circuit for heating in particular the electrochemical generator 1, and a second cooling or thermal energy recovery circuit for cooling in particular the electrochemical generator 1, wherein said fluid circulates. According to the present invention, in this first embodiment of FIG. 6, in conjunction with the air-conditioning circuit and the electrochemical generator 1, at least one electric motor 5 is also provided, for example a traction motor for the vehicle, and at least one electronic circuit 7, for example for controlling the electric motor or motors provided. The electronic circuit 7 or electronic equipment concerns both the electronics controlling the motor or motors 5 and the means controlling the valves, the control of the temperature sensor or sensors, a DC to DC conversion means, the control for charging the battery, in conjunction with a braking circuit or other components.

The electric motor or motors 5 and at least the electronic circuit 7 are also used for the recovery of thermal heating or cooling energy like the electrochemical generator 1. The electric motor or motors 5 and at least the electronic circuit 7 are arranged in a circuit in parallel with the electrochemical generator 1 in conjunction with the first heating circuit or with the second cooling circuit as explained below. This is an ideal configuration, since it is possible to measure the temperature of each element separately, which allows a clearly differentiated adaptation for a heating or cooling operation by recovery of thermal energy from the motor or motors 5, from the electronic circuit 7 or from the electrochemical generator 1.

A braking circuit 9 can also be provided and connected in parallel with the electric motor or motors 5, the electronic circuit or general electronics 7 and the electrochemical generator 1. This braking circuit 9 comprises essentially a resistor through which an electric current passes following the triggering of the braking of the vehicle by disk brakes or by braking by the electric motor 5. The resistor, connected by electric wires shown symbolically in FIG. 6, heats up during braking and heats the gas or liquid surrounding the resistor. This gas or liquid is transmitted in the conduits of the first heating circuit or of the second cooling circuit, passing through the battery 1 and at the electric motor or motors 5 and all the electronics 7. Thermal energy is essentially supplied and makes it possible to be transmitted in one of the heating or cooling circuits in order to provide positive heating energy to the cabin. This thermal energy can also serve to heat the electrochemical generator 1.

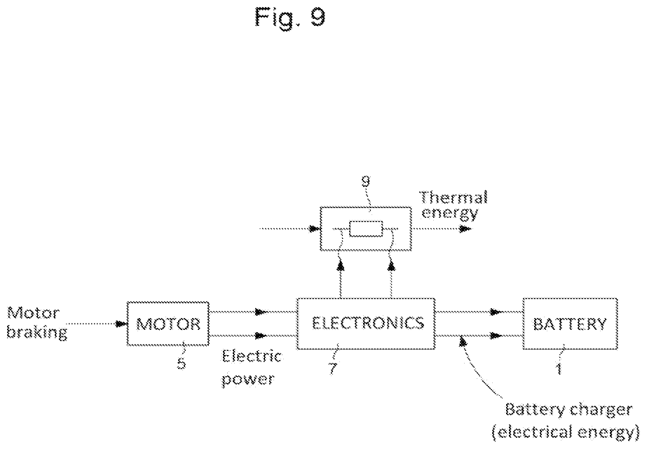

When there is a high speed of the electric vehicle, the emergency braking with the electric motor or motors 5 does not make it possible to charge the electrochemical generator 1 directly, since there are excessively strong currents passing in the motor. As shown schematically in FIG. 9, it is possible first of all to pass the energy into the electrical resistor 9 by passing through the electronics 7. Two electric-power electrical wires are connected at the output of the motor or motors 5 and at the input of the electronics 7, which connects as an output, by two electric wires, the two wires of the resistor of the braking circuit 9. Thermal energy is recovered at the output of the braking circuit 9 connected to the HVAC system and to the first heating circuit or to the second cooling circuit. When the power decreases in the motor or motors 5, at that moment it is possible to begin the charging of the electrochemical generator 1 with the electric power output from the electric motor or motors 5, passing through the electronics 7. Thus it is possible to imagine a vehicle without hydraulic brakes, which enables us to recover 100% of braking energy, either thermal or electrical, to charge the electrochemical generator 1. The electrical or thermal energy is therefore not lost and constitutes positive energy for charging or heating the electrochemical generator 1.

Four electric motors 5 can be imagined, that is to say one motor in each wheel of the vehicle, and performing very secure and independent braking for each wheel. A braking circuit 9 may be mounted on each wheel of the vehicle with each electric motor 5.

It should be noted that the circulation of the fluid, such as gaseous fluid, in the conduits in FIGS. 6 to 8 is illustrated only for the second cooling circuit, as for FIG. 5. The circulation of the fluid is shown by darker lines. However, the parts of the first heating circuit or heating thermal energy recovery circuit are also described below.

The first heating or thermal energy recovery circuit for heating the electrochemical generator 1 and at least the electric motor 5 of the electronic circuit 7, or even of the braking circuit 9, comprises a first fluid supply conduit 22. This first fluid supply conduit 22 brings the fluid to a heat-transfer element associated with the electrochemical generator 1 and to portions of conduit of at least the motor 5 and of at least the electronic circuit 7, or even of the braking circuit 9. The first heating circuit or heating thermal energy recovery circuit also comprises a first conduit 26 for discharging fluid from the heat-transfer element and from conduit portions of at least the motor 5 and of the electronic circuit 7. The first fluid discharge conduit 26 is connected to a first inlet of a 3-way return valve 28 between the internal condenser 6 and the first expansion orifice 8.

The first supply conduit 22 is connected to a first outlet of a first 3- way valve 24 provided between the compressor 4 and the internal condenser 6, and to a first inlet of a second 4-way valve 36. The fluid is transmitted from a first outlet of the second valve 36 to the heat-transfer element associated with the electrochemical generator 1, and from a second outlet of the second valve 36 to an inlet of a first complementary 4- way valve 37. A first outlet of this first complementary valve 37 is connected to the conduit portions of at least the electric motor 5, whereas the second outlet of the first complementary valve 37 is connected to the conduit portions of at least the electronic circuit 7 and the third outlet of the first complementary valve 37 is connected to the braking circuit 9 put in parallel with the electrochemical generator 1, the electric motor or motors 5 and the electronic circuit 7. The outputs of at least the electric motor 5, of at least the electronic circuit 7 and of the braking circuit 9 are connected to inlets of a second complementary 4-way valve 39, the outlet of which is connected to an inlet of a connection valve 41, the other inlet of which is connected to the heat-transfer element of the electrochemical generator 1. The outlet of this connection valve 41 is connected to a first inlet of a third 3-way valve 38, a first outlet of the third valve 38 joining the air-conditioning circuit via the valves 28 and 21 and regaining the external condenser/evaporator 2 by passing through the first expansion orifice 8.

As shown in FIG. 6, the second cooling or thermal energy recovery circuit for cooling of the electrochemical generator 1 and of at least the electric motor 5 and of at least the electronic circuit 7 and of the braking circuit 9 comprises a second fluid supply conduit 30. This second fluid supply conduit 30 brings the fluid to a heat-transfer element associated with the electrochemical generator 1 and to conduit portions of at least the motor 5 and of at least the electronic circuit 7 and of the braking circuit 9. The second cooling circuit or cooling thermal energy recovery circuit comprises a second conduit 34 for discharging fluid from the heat-transfer element associated with the electrochemical generator 1 and to conduit portions of at least the motor 5 and of at least the electronic circuit 7 and of the braking circuit 9.

According to the second cooling circuit or cooling thermal energy recovery circuit, the fluid that passes through the external condenser/evaporator 2 flows to the accumulator 3 via the valves 18 and 20 controlled by the control means, and then into the compressor 4, where it is compressed, and therefore heated, and then sent to the valve 24. The fluid also flows in the direction of the second expansion orifice 12 through the valve 18. The second fluid supply conduit 30 is connected to a second outlet of a fourth 3-way valve 32 provided between the second expansion orifice 12 and the internal evaporator 14, and to a second inlet of the second 4-way valve 36, whereas the second fluid discharge conduit 34 of the heat-transfer element passes through a second outlet of the third valve 38 and is connected to a second inlet of the fifth 4-way valve 20 provided downstream of the internal evaporator 14, between the internal evaporator 14 and the compressor 4. The energy A by the external condenser/evaporator 2 is added in the compressor 4 to the energy coming from the assembly composed of the electrochemical generator 1 and at least the electric motor 5 and at least the electronic circuit 7 and the braking circuit 9. A hot fluid enters the internal condenser 6 through the valve 24 and emerges colder from the internal condenser 6 in order to pass through the first expansion orifice 8 via the valve 21 and to regain the external condenser/evaporator 2.

As already stated above, a plurality of valves 18, 20, 21, 24, 28, 32, 36, 37, 38, 39 and 41 are arranged so as to be able to put the air- conditioning circuit in communication with one or other of the first heating circuit and the second cooling circuit for the electrochemical generator 1 and at least one electric motor 5 and at least one electronic circuit 7 and the braking circuit 9. In addition, means are provided for controlling said valves 18, 20, 21, 24, 28, 32, 36, 37, 38, 39 and 41 arranged to allow the circulation of the fluid from the air-conditioning circuit in the first heating circuit or in the second cooling circuit.

According to the temperature measured by at least one temperature sensor, which is associated with the means controlling the electrochemical generator 1 and at least the electric motor 5 and at least the electronic circuit 7 together or separately or even the braking circuit 9, the circulation of the fluid can go into the first heating circuit in order to heat the electrochemical generator 1 and the electric motor 5 and the electronic circuit 7 and the braking circuit 9, or to recover thermal energy for heating the electrochemical generator 1, the electric motor 5 and the electronic circuit 7 and optionally the braking circuit 9. The circulation of the fluid can also go into the second cooling circuit in order to cool the electrochemical generator 1 and the electric motor 5 and the electronic circuit 7, or even the braking circuit 9, or to recover thermal energy for cooling the electrochemical generator 1, the electric motor 5 and the electronic circuit 7, or even the braking circuit 9. This initially serves to regulate the temperature of the electrochemical generator 1 and/or of the electric motor 5 and/or of the electronic circuit 7, but may also serve to use the heat or cold coming from the electrochemical generator 1, from the electric motor 5 and from the electronic circuit 7 in particular in order to heat or cool the vehicle cabin.

As previously indicated with reference to FIGS. 1 to 5, the air- conditioning circuit may also comprise, in a first loop, a bypass 10 provided between the internal condenser 6 and the external condenser/evaporator 2, at the first expansion orifice 8. At the internal evaporator 14, a fan 16 for the air-conditioning unit may be provided. The circulation in the first loop or in the second loop and the bypass is managed by means of the valves 18 and 20, which are provided at the intersection of the first loop and of the second loop, and the valve 21 provided at the intersection of the first loop and of the bypass 10, upstream of the first expansion orifice 8. These valves are for example solenoid valves with at least 3 ways, or even at least 4 ways.

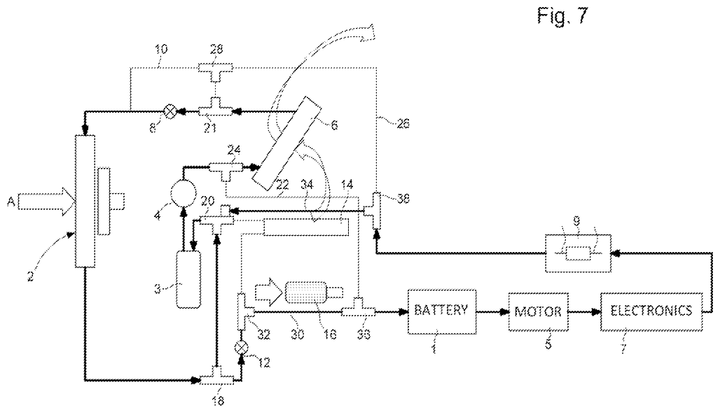

FIG. 7 shows a second embodiment of the novel thermal energy recovery and regulation device of the vehicle with electrochemical generator 1, which comprises an air-conditioning circuit of an HVAC system of the vehicle cabin. As before, a mode for cabin heating and cooling of the electrochemical generator 1 is presented in accordance with this second embodiment seen in FIG. 7, with at least one electric motor 5 and at least one electronic circuit 7. It may also be envisaged having a braking circuit 9. As this FIG. 7 comprises a major part of the identical components and a function equivalent to those of FIG. 6, only the differences with respect to the first embodiment will be described.

At least one electric motor 5 and at least one electronic circuit 7 are arranged in a connection in series with the electrochemical generator 1 and connected to the first heating circuit or to the second cooling circuit. A braking circuit 9 may also be connected in series with the electrochemical generator 1, the electric motor or motors 5 and the electronic circuit 7. In this configuration, the measurement of temperature of each element, namely the electrochemical generator 1, the traction electric motor 5, the electronic control circuit 7 and the braking circuit 9, is done by a temperature sensor in order to supply a common temperature and in order to make it possible to recover heat or cold from each of the elements to be used for heating or cooling the vehicle cabin, or even to charge the electrochemical generator 1 as explained previously.

The connection to the first heating circuit or to the second cooling circuit is made only by the second 3-way valve 36 and by the third 3-way valve 38 as the electrochemical generator 1, the traction electric motor 5, the electronic control circuit 7 and the braking circuit 9 are connected in series.

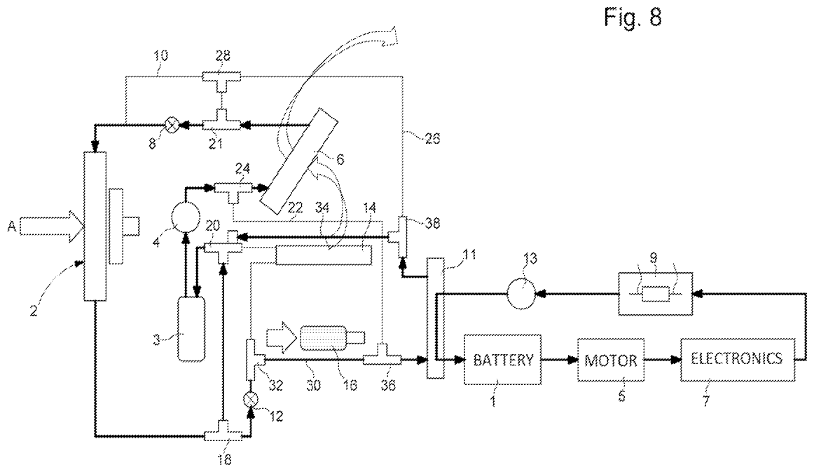

FIG. 8 shows a third embodiment of the novel thermal energy recovery and regulation device of the vehicle with electrochemical generator 1, which comprises an air-conditioning circuit of an HVAC system of the vehicle cabin. As before, according to this third embodiment seen in FIG. 8, a mode of cabin heating and cooling of the electrochemical generator 1 is presented, with at least one electric motor 5 and at least one electronic circuit 7 and a braking circuit 9. As this FIG. 8 comprises a major part of the identical components and of a function equivalent to those of FIG. 6, only the differences with respect to the first embodiment will be described.

At least one electric motor 5, at least one electronic circuit 7 and for example a braking circuit 9 are arranged in a connection in series with the electrochemical generator 1 and are connected by conduits in which water circulates as a fluid or another liquid (glycol). To do this, a pump 13 for circulating the liquid and an exchanger 11 receiving the liquid at the inlet of the assembly are provided, the assembly comprising the electrochemical generator 1, the electric motor 5, the electronic circuit 7 and the braking circuit 9. A connection is made either to the first heating circuit or to the second cooling circuit at the exterior inlet of the exchanger, which receives the gaseous fluid. Advantageously, a gas-liquid exchanger 11 rather than a gas-air exchanger is used.

As before, the measurement of temperature of each element, namely the electrochemical generator 1, the traction electric motor 5, the electronic control circuit 7 and the braking circuit 9, is done by a single temperature sensor in order to supply a common temperature and in order to make it possible to recover heat or cold from each of the elements for use for heating or cooling the vehicle cabin, or even for charging the electrochemical generator 1 as previously explained.

Naturally other elements of the electric vehicle can be envisaged, disposed in the closed circuit of the air-conditioning circuit for in particular recovery of thermal energy. Mention can be made in particular of the connection with a braking circuit of the vehicle, where a resistor able to heat up during braking can be used. This resistor may be disposed so as to be connected with the first heating circuit or the second cooling circuit. And under these conditions the heat can be taken off or recovered in order to be transmitted in the vehicle in order to heat the cabin. The circuit connected to the braking circuit may be in direct connection through the resistor with the first heating circuit or the second cooling circuit. Thus any element able to heat or cool the electric vehicle may be used in connection to the air-conditioning circuit in order to recover heat or cold to be transmitted in particular into the vehicle cabin.

Naturally the present invention is not limited to the examples illustrated and is capable of diverse variants and modifications that will be obvious to a person skilled in the art. Other combinations are of course possible with already what is known with the electrochemical generator, the traction electric motor or motors, and the electronic circuit controlling the motor or motors.

Claims

1

-

11

. (Cancelled)

12. A device for recovering and regulating thermal energy of an electric vehicle with an electrochemical generator, said electrochemical generator being chosen from a group comprising batteries and fuel cells or hybrids, said regulation device comprising:
an air-conditioning circuit of an HVAC system of a vehicle cabin where a fluid circulates, said air-conditioning circuit comprising
at least one external condenser/evaporator,
a compressor,
an internal condenser intended to heat the cabin,
a first expansion orifice provided downstream of the internal condenser between the internal condenser and the external condenser/evaporator,
an internal evaporator intended to cool the cabin, and
a second expansion orifice provided upstream of the internal evaporator, between the external condenser/evaporator and the internal evaporator;
a first heating or thermal energy recovery circuit of the electrochemical generator where said fluid circulates, said first heating circuit of the electrochemical generator comprising
a first fluid supply conduit for supplying the fluid to a heat-transfer element associated with the electrochemical generator, said first fluid supply conduit being connected to a first outlet provided between the compressor and the internal condenser, and
a first fluid discharge conduit for discharging the fluid from the heat-transfer element, which is connected to a first inlet provided between the internal condenser and the first expansion orifice; and
a second cooling or thermal energy recovery circuit of the electrochemical generator, said second cooling circuit of the electrochemical generator comprising
a second fluid supply conduit for supplying fluid to the heat-transfer element associated with the electrochemical generator, said second fluid supply conduit being connected to a second outlet provided between the second expansion orifice and the internal evaporator,
a second fluid discharge conduit of the heat-transfer element, which is connected to a second inlet provided downstream of the internal evaporator, between the internal evaporator and the compressor,
a plurality of valves being configured to put the air-conditioning circuit in communication with one or other of the first heating circuit and second cooling circuit of the electrochemical generator, and
means of controlling said valves arranged to allow, according to a temperature of the electrochemical generator, the circulation of the fluid from the air-conditioning circuit in the first heating circuit to heat the electrochemical generator or to recover heating thermal energy from the electrochemical generator, as well as the circulation of the fluid from the air- conditioning circuit in the second cooling circuit to cool the electrochemical generator or to recover cooling thermal energy from the electrochemical generator, wherein
the thermal energy recovery and regulation device further comprises at least one electric motor and at least one electronic circuit, both arranged to be connected to the first heating circuit or to the second cooling circuit connected to the electrochemical generator, said at least one electric motor and said at least one electronic circuit being configured to recover heating or cooling thermal energy.

13. The thermal energy recovery and regulation device according to claim 12, wherein said at least one electric motor and said at least one electronic circuit are arranged in parallel with the electrochemical generator connected to the first heating circuit or to the second cooling circuit.

14. The thermal energy recovery and regulation device according to claim 12, wherein said at least one electric motor and said at least one electronic circuit are arranged in series with the electrochemical generator connected to the first heating circuit or to the second cooling circuit.

15. The thermal energy recovery and regulation device according to claim 12, wherein
said at least one electric motor and said at least one electronic circuit are arranged in series with the electrochemical generator while being connected by conduits in which a liquid circulates,
the device further comprises a pump for circulating the liquid and a gas-liquid heat exchanger receiving the liquid at an inlet of the assembly, which comprises the electrochemical generator, the at least one electric motor and the at least one electronic circuit, and
a connection is made either to the first heating circuit or to the second cooling circuit at the external inlet of the exchanger, which receives gaseous fluid.

16. The thermal energy recovery and regulation device according to claim 12, further comprising a braking circuit of the vehicle with a resistor configured to heat up during braking, said resistor being disposed in connection with the first heating circuit or the second cooling circuit for recovery of thermal energy.

17. The thermal energy recovery and regulation device according to claim 12, wherein said at least one electric motor, said at least one electronic circuit, and a braking circuit are arranged in parallel with the electrochemical generator connected to the first heating circuit or to the second cooling circuit.

18. The thermal energy recovery and regulation device according to claim 17, wherein the braking circuit comprises essentially a resistor through which an electric current passes following a triggering of a braking of the vehicle, the resistor heating up during the braking and heating a gaseous or liquid fluid surrounding the resistor to provide thermal energy for heating the cabin or the electrochemical generator.

19. The thermal energy recovery and regulation device according to claim 17, further comprising four traction electric motors, with one of the four traction electric motors in each wheel of the vehicle, configured to effect secure independent braking for each wheel while recovering a more precise thermal energy from the braking circuit.

20. The thermal energy recovery and regulation device according to claim 12, wherein said at least one electric motor, said at least one electronic circuit, and a braking circuit are arranged in series with the electrochemical generator connected to the first heating circuit or to the second cooling circuit.

21. The thermal energy recovery and regulation device according to claim 20, wherein the braking circuit comprises essentially a resistor through which an electric current passes following a triggering of a braking of the vehicle, the resistor heating up during the braking and heating a gaseous or liquid fluid surrounding the resistor to provide thermal energy for heating the cabin or the electrochemical generator.

22. The thermal energy recovery and regulation device according to claim 20, further comprising four traction electric motors, with one of the four traction electric motors in each wheel of the vehicle, configured to effect secure independent braking for each wheel while recovering a more precise thermal energy from the braking circuit.

23. The thermal energy recovery and regulation device according to claim 12, wherein
said at least one electric motor, said at least one electronic circuit, and a braking circuit are arranged in series with the electrochemical generator while being connected by conduits wherein a liquid circulates,
the device further comprises a pump for circulating the liquid and a gas-liquid heat exchanger receiving the liquid at an inlet of the assembly, which comprises the electrochemical generator, the at least one electric motor and the at least one electronic circuit, and
a connection is made either to the first heating circuit or to the second cooling circuit at the external inlet of the exchanger, which receives the gaseous fluid.

24. The thermal energy recovery and regulation device according to claim 23, wherein the braking circuit comprises essentially a resistor through which an electric current passes following the triggering of a braking of the vehicle, the resistor heating up during the braking and heating a gaseous or liquid fluid surrounding the resistor in order to provide thermal energy for heating the cabin or the electrochemical generator.

25. The thermal energy recovery and regulation device according to claim 23, further comprising four traction electric motors, with one of the four traction electric motors in each wheel of the vehicle, configured to effect secure independent braking for each wheel while recovering a more precise thermal energy from the braking circuit.

26. The thermal energy recovery and regulation device according to claim 25, wherein the braking circuit is mounted on each wheel of the vehicle with each one of the four traction electric motors.
